(19) United States
(12) Patent Application Publication
(10) Pub. No.: US 2005/0024812 A1
(43) Pub. Date: Feb. 3, 2005

(54) Semiconductor device with capacitor and manufacturing method thereof

(75) Inventor: Naoki Yokoi, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/853,203

(22) Filed: May 26, 2004

(30) Foreign Application Priority Data
Jun. 5, 2003 (JP) 2003-161143

(51) Int. Cl. H01G 4/228

(52) U.S. Cl. 361/306.3

(57) ABSTRACT

After a conductive film serving as a capacitor lower electrode is formed, the subsequent process steps are performed with the capacitor lower electrode always supported by an interlayer insulating film, a conductive film serving as a portion of a capacitor upper electrode, and a capacitor dielectric film. Therefore, complete exposure of the conductive film serving as the capacitor lower electrode does not take place during a manufacturing process of a semiconductor device. Consequently, a disadvantage that the conductive film serving as the capacitor lower electrode is bent can be avoided. A method of manufacturing a semiconductor device achieving improvement in a yield thereof and a semiconductor device manufactured with such a manufacturing method can thus be obtained.

### BACKGROUND OF THE INVENTION

1. Field of the Invention

The present invention relates to a semiconductor device with a capacitor and a manufacturing method thereof

2. Description of the Background Art

A semiconductor device with a capacitor of a type of a round tube or an angular tube formed so as to extend in a direction vertical to a main surface of a semiconductor substrate above the same has conventionally been employed. In a process step of forming such a capacitor, a capacitor lower electrode formed on an interlayer insulating film is once exposed completely. When the capacitor lower electrode is completely exposed, a capacitor dielectric film is formed along a surface of the round tube or the angular tube described above.

According to a method of manufacturing a semiconductor device described above, the capacitor dielectric film is formed on the surface of the capacitor lower electrode without a member around the capacitor lower electrode to support the same. In other words, the capacitor dielectric film is formed on the capacitor lower electrode in a state extremely unstable in terms of structure of the capacitor lower electrode. Even with such a method, no problem has arisen because an aspect ratio of the capacitor lower electrode has been small in a conventional semiconductor device.

In recent years, however, a larger aspect ratio of the capacitor lower electrode has been demanded in order to increase capacitance. In such a capacitor, the capacitor lower electrode may be bent during a process step of forming the capacitor dielectric film due to its insufficient mechanical strength. As a result, a yield of a semiconductor device may be lowered.

### SUMMARY OF THE INVENTION

The present invention was made in view of the above-described problems. An object of the present invention is to provide a semiconductor device in which an aspect ratio of a capacitor lower electrode can be made larger in order to increase capacitance, as well as a manufacturing method thereof.

Another object of the present invention is to provide a semiconductor device in which bending of a capacitor lower electrode during a manufacturing process is prevented so as to improve the a yield, as well as a manufacturing method thereof.

A semiconductor device according to one aspect of the present invention is configured in the following manner.

The semiconductor device includes a capacitor lower electrode of a shape of a round tube or an angular tube formed above a semiconductor device. A first capacitor dielectric film is provided along an entire outer side surface of the capacitor lower electrode. A first capacitor upper electrode is formed so as to cover an entire outer side surface of the first capacitor dielectric film. A second capacitor dielectric film is formed so as to extend along a surface of a hole formed by the capacitor lower electrode and so as to cover an upper surface of the capacitor lower electrode, an upper surface of the first capacitor dielectric film, and an upper surface of the first capacitor upper electrode.

A second capacitor upper electrode is formed so as to extend along an upper surface of the second capacitor dielectric film and so as to fill a hole formed by the second capacitor dielectric film. A plug extending in a direction vertical to a main surface of the semiconductor substrate and connecting the first capacitor upper electrode to the second capacitor upper electrode is provided.

A semiconductor device according to another aspect of the present invention is configured in the following manner.

The semiconductor device has a capacitor lower electrode of a shape of a column or a prism formed so as to extend in a direction vertical to a main surface of a semiconductor substrate above the same. A first capacitor dielectric film is formed so as to cover an entire outer side surface of the capacitor lower electrode. A first capacitor upper electrode is formed so as to cover an entire outer side surface of the first capacitor dielectric film. A second capacitor dielectric film is formed so as to cover each upper surface of the capacitor lower electrode, the first capacitor dielectric film and the first capacitor upper electrode. A second capacitor upper electrode is formed so as to cover an upper surface of the second capacitor dielectric film. A plug formed so as to extend in a direction vertical to the main surface of the semiconductor substrate and connecting the first capacitor upper electrode to the second capacitor upper electrode is provided.

When the structure of the semiconductor device according to one and another aspects described above is adopted, a manufacturing method described later can be employed. Hence, the aspect ratio of the capacitor lower electrode can be made larger in order to increase capacitance.

A method of manufacturing a semiconductor device according to one aspect of the present invention includes the following steps.

In the method of manufacturing a semiconductor device, initially, a first conductive film serving as a capacitor upper electrode is formed above a semiconductor substrate. Then, a first hole is formed in the first conductive film so as to extend in a direction vertical to a main surface of the semiconductor substrate. Thereafter, a first dielectric film serving as a capacitor dielectric film is formed along an entire surface of the first hole. Then, a second conductive film serving as the capacitor lower electrode is formed along an entire surface of a second hole formed by the first dielectric film. A second dielectric film is then formed along a surface of a third hole formed by the second conductive film, an upper surface of the second conductive film, an upper surface of the first dielectric film, and an upper surface of the first conductive film. Thereafter, a third conductive film serving as a capacitor upper electrode is formed so as to extend along an upper surface of the second dielectric film and so as to fill a fourth hole formed by the second dielectric film. Finally, a plug penetrating the third conductive film and the second dielectric film to reach the first conductive film is formed.

A method of manufacturing a semiconductor device according to another aspect of the present invention includes the following steps.

In the method of manufacturing a semiconductor device, initially, a first conductive film serving as a capacitor upper electrode is formed above a semiconductor substrate. Then, a first hole is formed in the first conductive film in a direction vertical to a main surface of the semiconductor substrate. Thereafter, a first dielectric film serving as a capacitor dielectric film is formed along an entire surface of the first hole. Then, a second conductive film serving as a capacitor lower electrode is formed so as to fill a second hole formed by the first dielectric film. Thereafter, a second dielectric film serving as a capacitor dielectric film is formed so as to cover each upper surface of the second conductive film, the first dielectric film and the first conductive film. A third conductive film serving as a capacitor upper electrode is then formed so as to cover an upper surface of the second dielectric film. Finally, a plug penetrating the third conductive film and the second dielectric film to reach the first conductive film is formed.

In the method of manufacturing a semiconductor device according to one and another aspects described above, while the capacitor lower electrode is supported by the dielectric film, subsequent steps are performed. In other words, complete exposure of the capacitor lower electrode as in the conventional art does not take place. Therefore, a possibility of bending of the capacitor lower electrode during the manufacturing process is reduced, which leads to improvement in the a yield of the semiconductor device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a structure of a semiconductor device in a first embodiment.

FIGS. 2 to 15 illustrate a method of manufacturing a semiconductor device in the first embodiment.

FIG. 16 illustrates a structure of a semiconductor device in a second embodiment.

FIGS. 17 to 28 illustrate a method of manufacturing a semiconductor device in the second embodiment.

FIG. 29 illustrates a structure of a semiconductor device in a third embodiment.

FIGS. 30 to 36 illustrate a method of manufacturing a semiconductor device in the third embodiment.

FIG. 37 illustrates a structure of a semiconductor device in a fourth embodiment.

FIGS. 38 to 44 illustrate a method of manufacturing a semiconductor device in the fourth embodiment.

### DESCRIPTION OF THE PREFERRED EMBODIMENTS

In the following, a semiconductor device and a manufacturing method thereof in embodiments of the present invention will be described with reference to the figures.

### First Embodiment

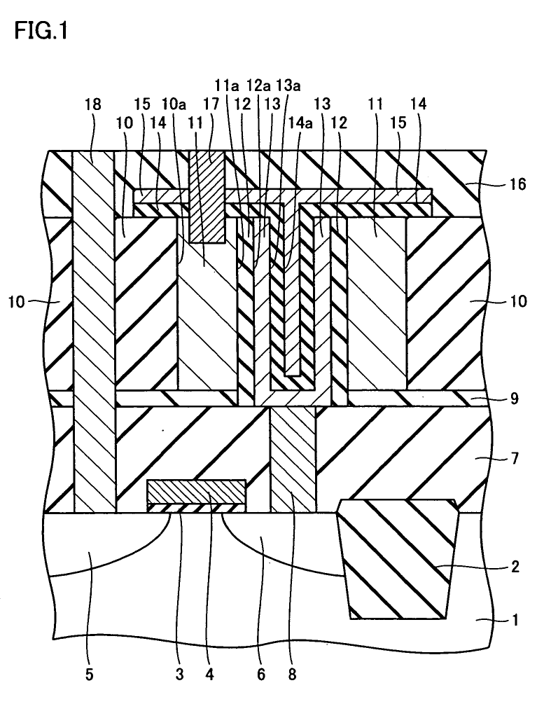

Initially, a semiconductor device and a manufacturing method thereof in the present embodiment will be described with reference to FIGS. 1 to 15. A structure of the semiconductor device in the present embodiment will now be described with reference to FIG. 1.

As shown in FIG. 1, the semiconductor device in the present embodiment is structured in the following manner. In a semiconductor substrate 1, an element isolation insulating film 2 composed of a silicon oxide film is formed from a position at a prescribed height above the main surface of semiconductor substrate 1 to a position at a prescribed depth below the same. In a region surrounded by element isolation insulating film 2, source/drain regions 5, 6 are formed. A gate insulating film 3 and a gate electrode 4 are formed between source/drain regions 5, 6.

An interlayer insulating film 7 is formed so as to cover the main surface of semiconductor substrate 1, gate insulating film 3, gate electrode 4, and element isolation insulating film 2. A contact plug 8 vertically penetrating interlayer insulating film 7 composed of a silicon oxide film to reach source/drain region 6 is formed. Contact plug 8 is fabricated with a polycrystalline silicon film containing an impurity. A silicon nitride film 9 is formed so as to cover an upper surface of interlayer insulating film 7. Silicon nitride film 9 attains a function as a stopper film in the step of forming a hole described later.

An interlayer insulating film 10 composed of a silicon oxide film is formed on silicon nitride film 9. A hole 10a penetrating interlayer insulating film 10 in a vertical direction is formed. In hole 10a, a conductive film 11 composed of TiN is formed along its inner surface. Conductive film 11 implements the capacitor upper electrode. A hole 11a penetrating in a direction vertical to the main surface of semiconductor substrate 1 is formed in conductive film 11. A dielectric film 12 is formed along an inner surface of hole 11a. Dielectric film 12 serves as the capacitor dielectric film, and is composed of Ta₂O₅.

A hole 12a is formed in dielectric film 12. A conductive film 13 is formed on the entire inner surface of hole 12a so as to be in contact with contact plug 8. Conductive film 13, shaped like a round tube or an angular tube, implements the capacitor lower electrode. Conductive film 13 is formed with a polycrystalline silicon film containing an impurity. A hole 13a is formed in conductive film 13.

A dielectric film 14 is formed along an entire surface of hole 13a and an upper surface of conductive film 13, dielectric film 12 and conductive film 11. A conductive film 15 is formed so as to fill a hole 14a formed by dielectric film 14 and so as to cover an upper surface of dielectric film 14. An interlayer insulating film 16 composed of a silicon oxide film is formed so as to cover dielectric film 14 and conductive film 15.

A plug 17 penetrating interlayer insulating film 16, conductive film 15 and dielectric film 14 in a direction vertical to the main surface of semiconductor substrate 1 to reach conductive film 11 is formed. Plug 17 is fabricated with a metal film such as a barrier metal film composed of TiN and Ti and W. Here, conductive film 11, plug 17 and conductive film 15 constitute the capacitor upper electrode. Dielectric film 12 and dielectric film 14 form the capacitor dielectric film. In addition, a contact plug 18 penetrating interlayer insulating film 16, interlayer insulating film 10, silicon nitride film 9, and interlayer insulating film 7 to reach source/drain region 5 is formed.

According to the semiconductor device with the capacitor structured in the above-described manner, the entire inner surface and the entire outer side surface of conductive film 13 can contribute as the capacitor. Therefore, the capacitance can be increased.

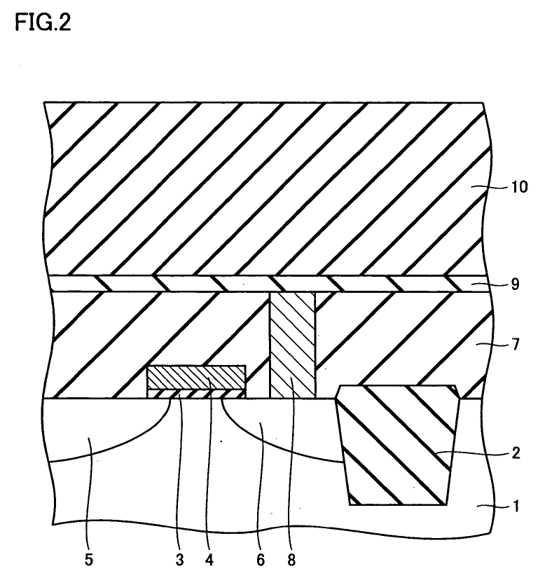

The method of manufacturing the semiconductor device in the present embodiment will now be described with reference to FIGS. 2 to 15.

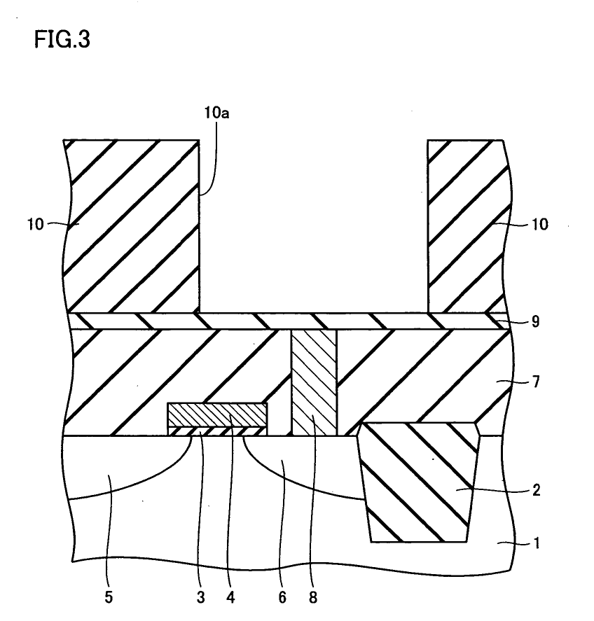

In the structure shown in FIG. 2, since the structure of silicon nitride film 9 and components below the same is substantially the same as that in the semiconductor device described with reference to FIG. 1, description thereof will not be repeated. As shown in FIG. 2, interlayer insulating film 10 composed of a silicon oxide film is formed on silicon nitride film 9. After a photolithography step, interlayer insulating film 10 is etched so as to form hole 10a as shown in FIG. 3. Hole 10a is formed above contact plug 8.

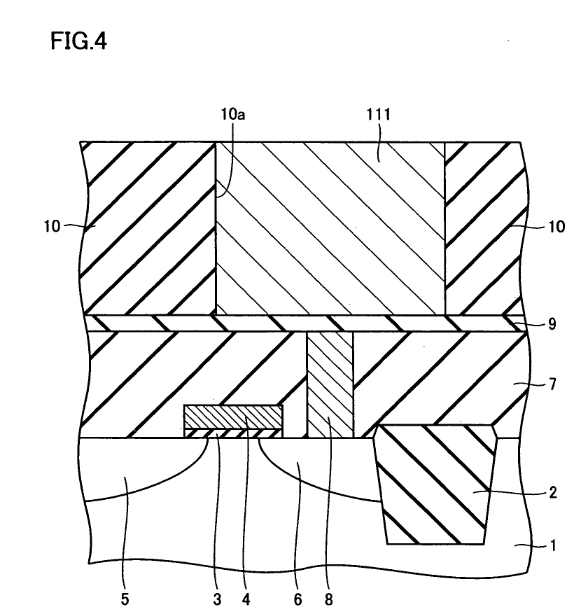

Then, a conductive film composed of TiN is formed so as to extend along the upper surface of interlayer insulating film 10 and so as to fill hole 10a. Thereafter, the conductive film is polished with CMP (Chemical Mechanical Polishing) so as to expose the upper surface of interlayer insulating film 10. A conductive film 111 is thus formed, as shown in FIG. 4.

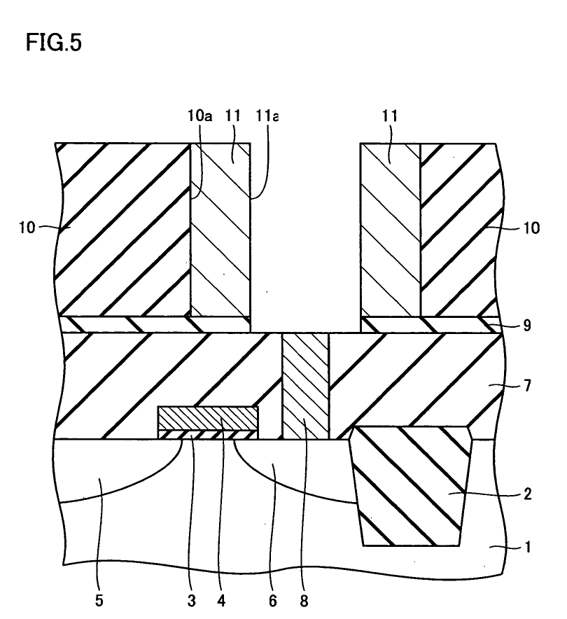

Thereafter, as shown in FIG. 5, conductive film 111 is etched to provide conductive film 11 and hole 11a. Here, silicon nitride film 9 is etched, and contact plug 8 is exposed on the bottom surface of hole 11a.

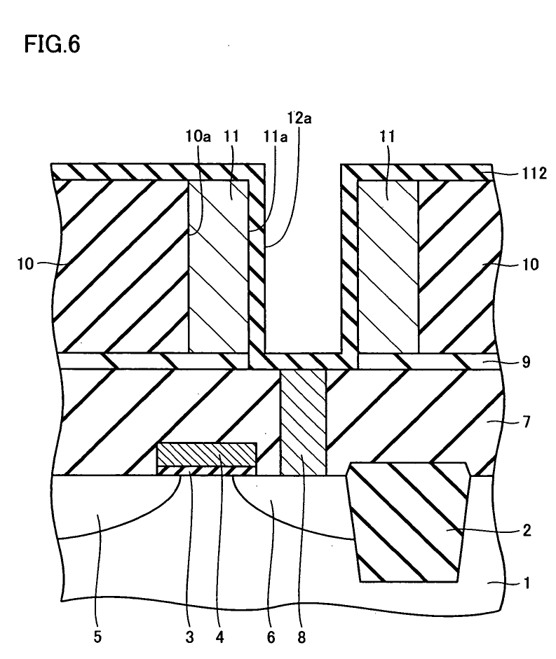

Then, a dielectric film 112 composed of Ta₂O₅ is formed along the surface of hole 11a, the upper surface of conductive film 11, and the upper surface of interlayer insulating film 10. The structure is shown in FIG. 6.

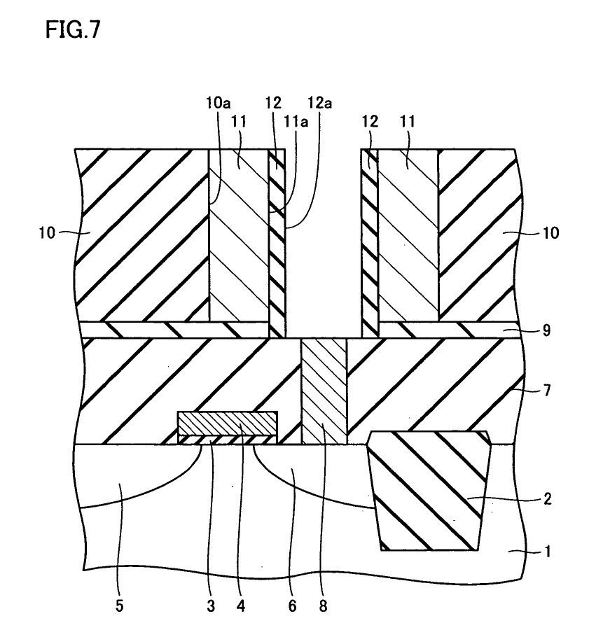

Dielectric film 112 is now removed by dry etch back. In this manner, the upper surface of interlayer insulating film 10 and conductive film 11 is exposed, and the upper surface of contact plug 8 and interlayer insulating film 7 is exposed. The structure is shown in FIG. 7. After this process step, dielectric film 12 still remains on the entire inner surface of hole 11a of conductive film 11. Here, hole 12a is formed in dielectric film 12.

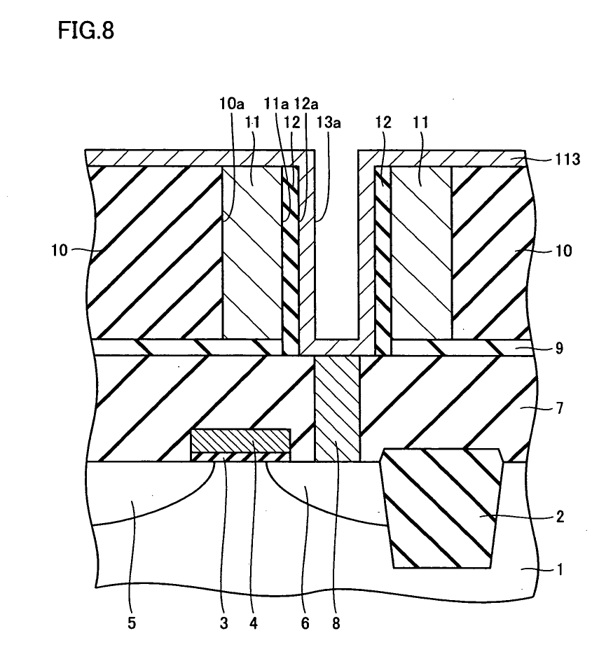

As shown in FIG. 8, a conductive film 113 composed of polycrystalline silicon containing an impurity is formed along a surface of hole 12a, the upper surface of conductive film 11, and the upper surface of interlayer insulating film 10. Here, the surface of conductive film 113 may be roughened by HSG (Hemi Spherical Grained) treatment.

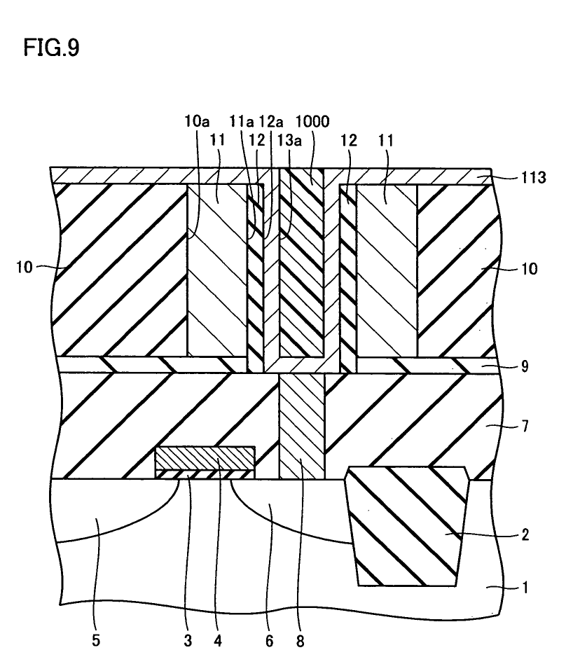

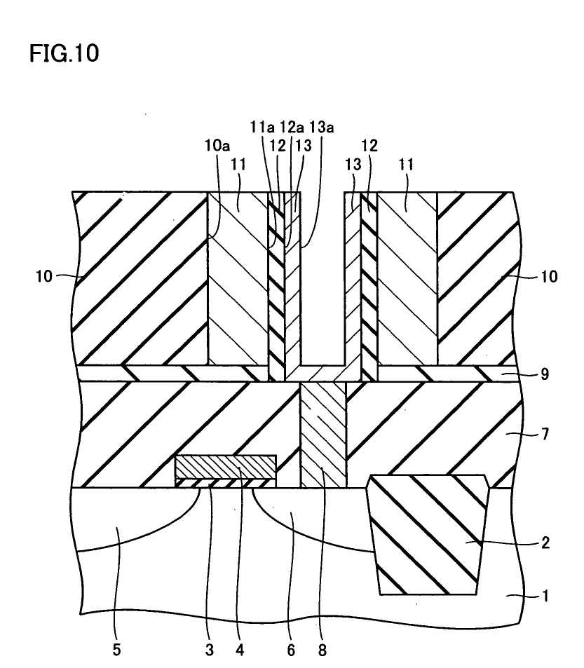

Thereafter, as shown in FIG. 9, a resist film 1000 is formed so as to fill hole 13a formed by conductive film 113. Then, using resist film 1000 as a mask, conductive film 113 is etched. Then, resist film 1000 is removed. In this manner, the structure shown in FIG. 10 is obtained. In the structure shown in FIG. 10, conductive film 13 implementing the capacitor lower electrode is shaped like a round tube or an angular tube. The hole formed by conductive film 13 is referred to as hole 13a.

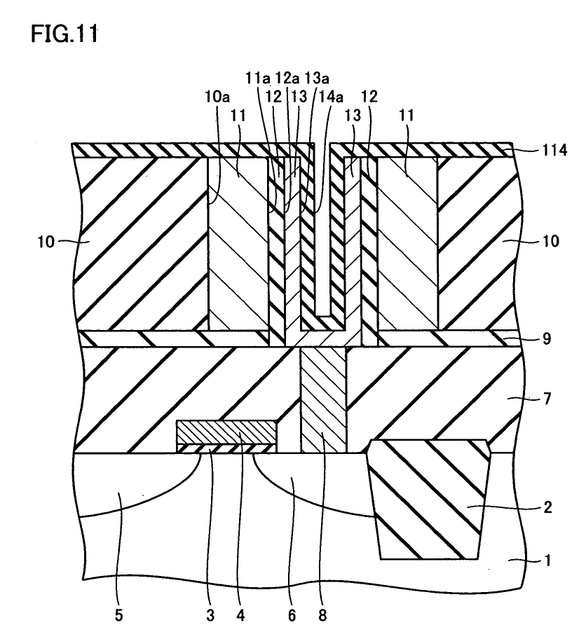

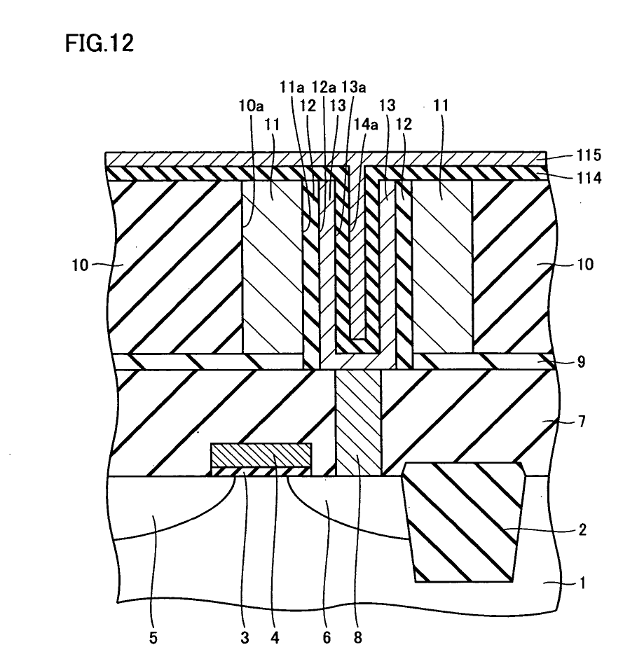

As shown in FIG. 11, a dielectric film 114 composed of Ta₂O₅ is formed along the surface of hole 13a, the upper surface of conductive film 13, the upper surface of conductive film 11, and the upper surface of interlayer insulating film 10. Then, a conductive film 115 is formed so as to extend along the upper surface of dielectric film 114 and so as to fill hole 14a formed by dielectric film 114. Here, conductive film 115 is composed of TiN. The structure is shown in FIG. 12.

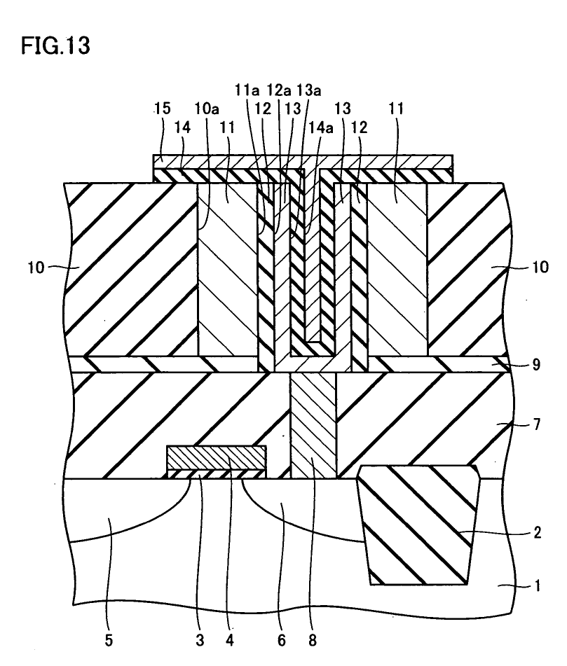

Thereafter, by dry etching, conductive film 115 and dielectric film 114 are patterned to form a prescribed pattern. In this manner, the structure as shown in FIG. 13 is obtained. In the structure as shown in FIG. 13, dielectric film 14 and conductive film 15 remain on conductive film 11.

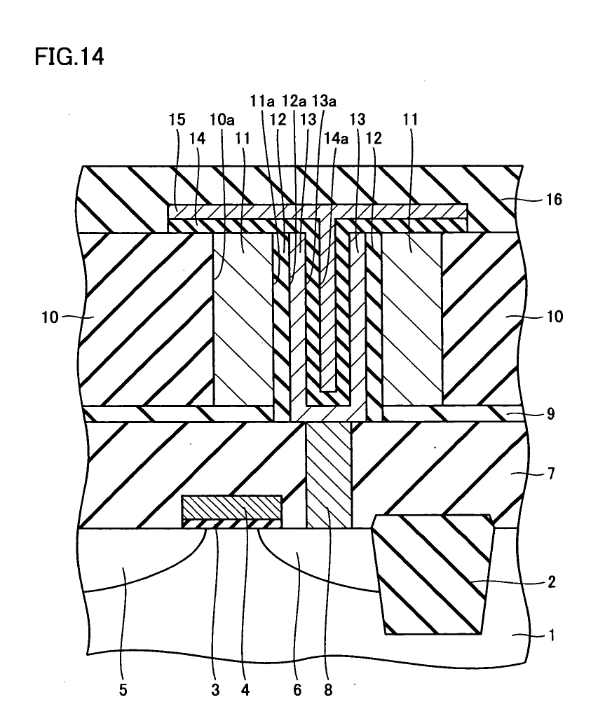

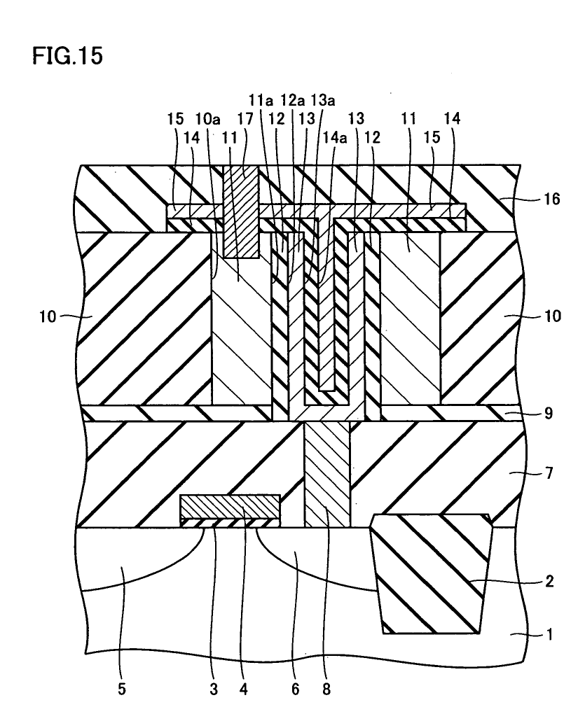

Interlayer insulating film 16 is formed so as to cover conductive film 15 and dielectric film 14. The structure is shown in FIG. 14. Then, a hole penetrating interlayer insulating film 16, conductive film 15 and dielectric film 14 to reach conductive film 11 is formed. The hole is filled with a plug fabricated with the barrier metal film composed of TiN and Ti and a W film. The structure is shown in FIG. 15.

Then, a hole penetrating interlayer insulating film 16, interlayer insulating film 10, silicon nitride film 9, and interlayer insulating film 7 to reach source/drain region 5 is formed. Contact plug 18 fills this hole, and the structure shown in FIG. 1 is obtained.

According to the method of manufacturing a semiconductor device described above, after conductive film 13 is formed, the subsequent process steps are performed with conductive film 13 serving as the capacitor lower electrode shown in FIG. 8 to 10 always supported by dielectric film 12 during the manufacturing process thereof. Accordingly, exposure of conductive film 13 serving as the capacitor lower electrode without support by any support member does not take place, as in the conventional method of manufacturing a semiconductor device. Therefore, a disadvantage that conductive film 13 serving as the capacitor lower electrode is bent is prevented, and the capacitor is satisfactorily formed. Consequently, a yield of the semiconductor device is improved.

### Second Embodiment

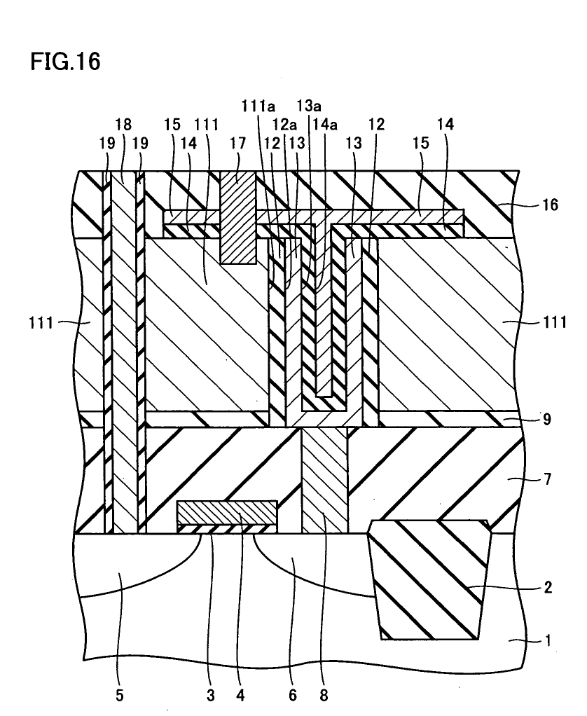

A semiconductor device and a manufacturing method thereof in the second embodiment will now be described with reference to FIGS. 16 to 28. First, a structure of the semiconductor device in the present embodiment will be described with reference to FIG. 16. As shown in FIG. 16, the semiconductor device in the present embodiment has a structure substantially the same as that of the semiconductor device in the first embodiment shown with reference to FIG. 1. The semiconductor device in the present embodiment, however, is different from the semiconductor device in the first embodiment in that interlayer insulating film 10 shown in FIG. 1 is not formed but conductive film 111 is formed instead.

Conductive film 111 is composed of TiN, and implements the capacitor lower electrode. Conductive film 111 is formed so as to spread all over in a memory cell region. In addition, an insulating film 19 is formed so as to surround contact plug 18. Insulating film 19 serves to isolate conductive film 111 from contact plug 18. Except for the structure described above, the structure of the semiconductor device in the present embodiment is exactly the same as that of the semiconductor device in the first embodiment shown in FIG. 1. That is, as the same or corresponding components designated by the same reference characters serve in a similar manner and attain the same function, description thereof will not be repeated.

According to the semiconductor device in the present embodiment with the capacitor structured in the above-described manner, the entire inner surface and the entire outer side surface of conductive film 13 can contribute as the capacitor, as in the semiconductor device in the first embodiment. Therefore, the capacitance can be increased.

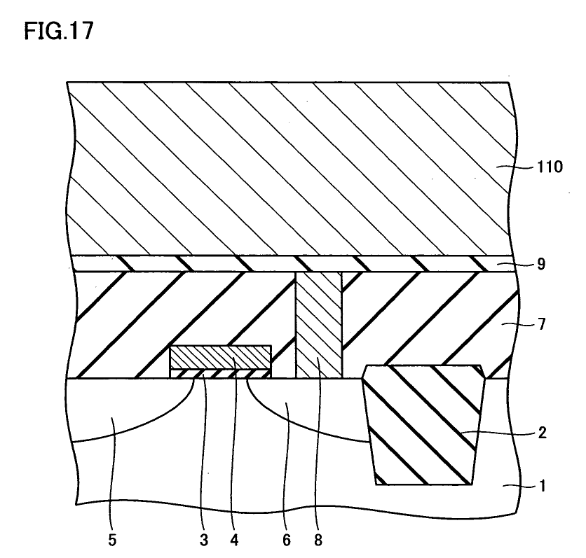

The method of manufacturing the semiconductor device in the present embodiment will now be described with reference to FIGS. 17 to 28. In FIG. 17, the steps until silicon nitride film 9 is formed are exactly the same as those in the method of manufacturing the semiconductor device in the first embodiment.

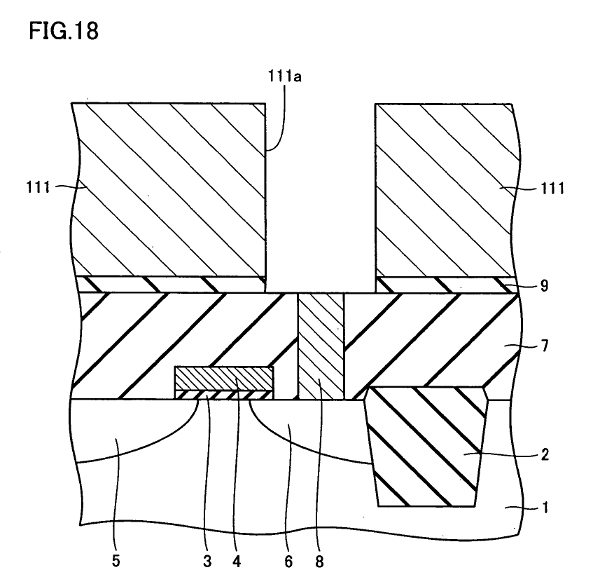

In FIG. 17, a conductive film 110 composed of TiN is formed on silicon nitride film 9. Then, conductive film 110 and silicon nitride film 9 are etched to form conductive film 111 with a hole 111a, as shown in FIG. 18. Hole 111a is formed above contact plug 8. Therefore, the upper surface of contact plug 8 is exposed on the bottom surface of hole 111a.

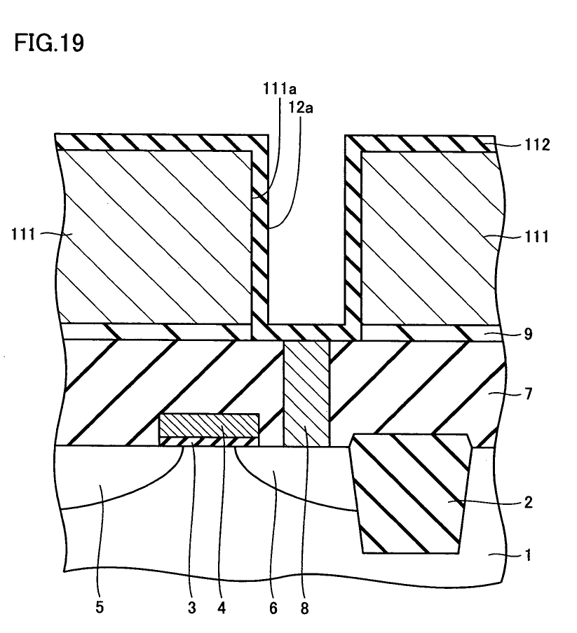

Then, dielectric film 112 is formed along the surface of 111a and the upper surface of conductive film 111. Dielectric film 112 is composed of Ta₂O₅. The structure is shown in FIG. 19.

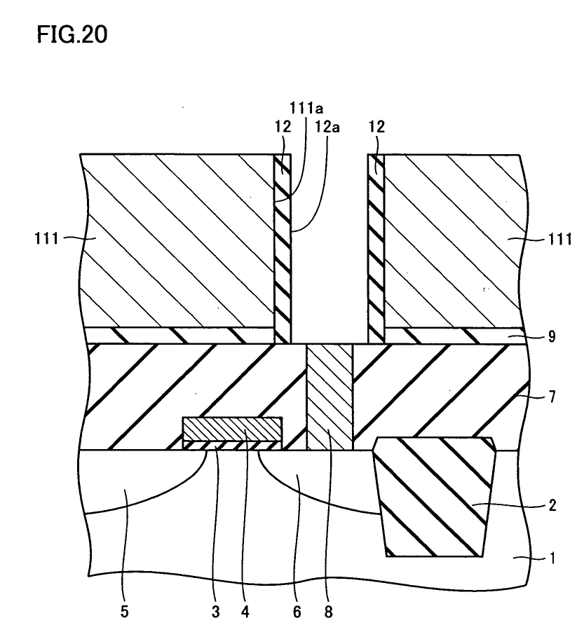

Thereafter, by dry etching, namely anisotropic etching, dielectric film 112 is removed. As a result, as shown in FIG. 20, dielectric film 12 is formed solely along the inner side surface of hole 111a of conductive film 111. Here, contact plug 8 is exposed on the bottom surface of hole 12a formed by dielectric film 12.

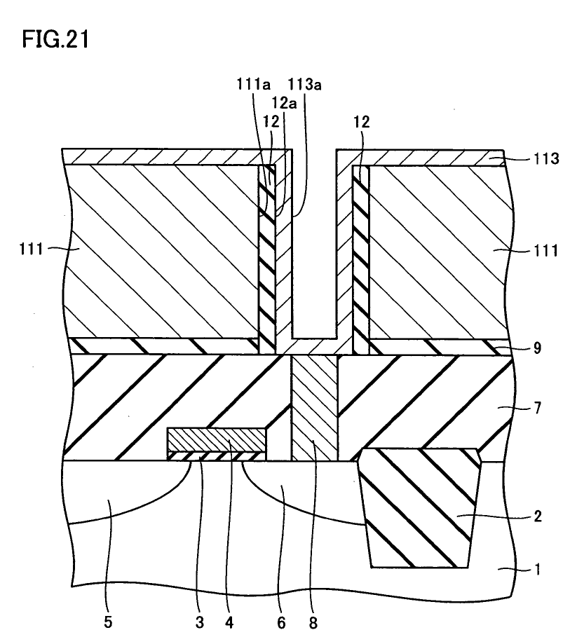

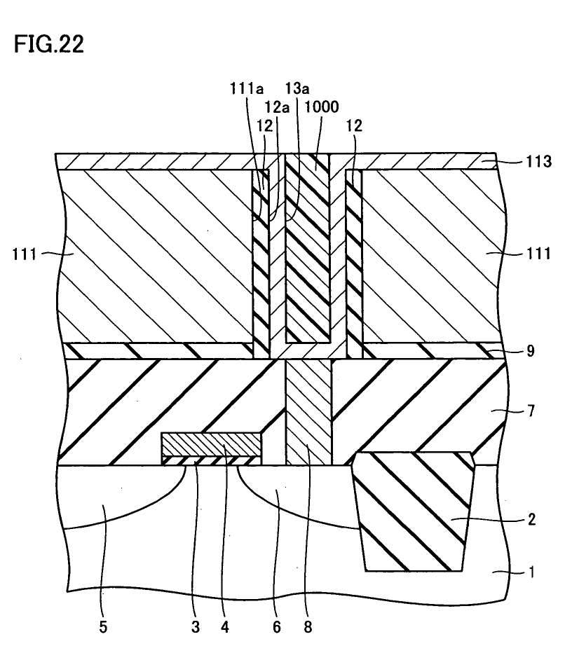

As shown in FIG. 21, conductive film 113 composed of polycrystalline silicon containing an impurity is formed along the surface of hole 12a, the upper surface of dielectric film 12, and the upper surface of conductive film 111. Thereafter, resist film 1000 is formed so as to fill hole 13a formed by conductive film 113. The structure is shown in FIG. 22.

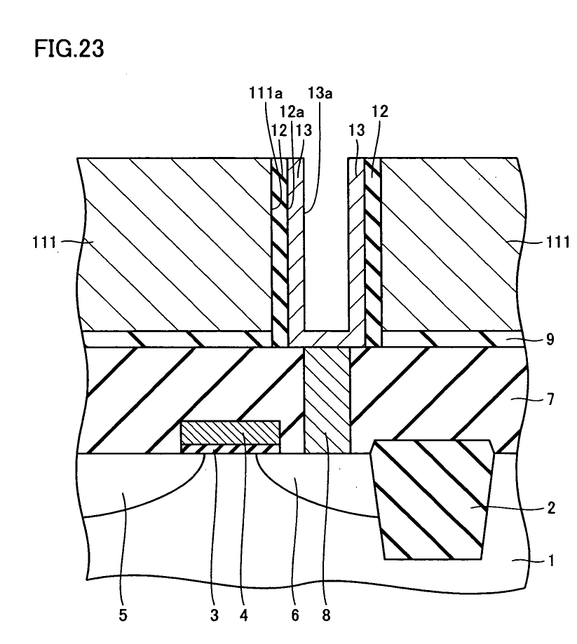

Then, using resist film 1000 as a mask, conductive film 113 is etched so as to expose the upper surface of conductive film 111 and the upper surface of dielectric film 12. Thereafter, resist film 1000 is removed. In this manner, the structure as shown in FIG. 23 is obtained.

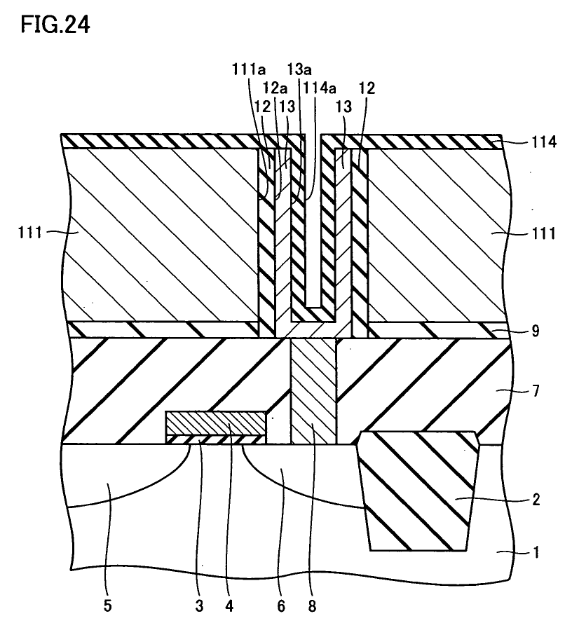

As shown in FIG. 24, dielectric film 114 is formed along the surface of hole 13a formed by conductive film 13, the upper surface of conductive film 13, the upper surface of dielectric film 12, and the upper surface of conductive film 111. Dielectric film 114 is composed of Ta₂O₅.

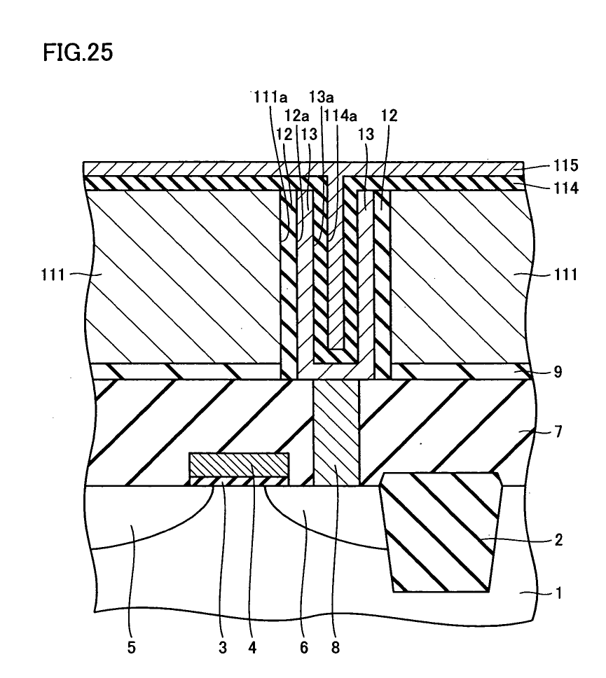

Then, conductive film 115 is formed so as to extend along the upper surface of dielectric film 114 and so as to fill a hole 114a formed by dielectric film 114. Conductive film 115 is composed of TiN. In this manner, the structure as shown in FIG. 25 is obtained.

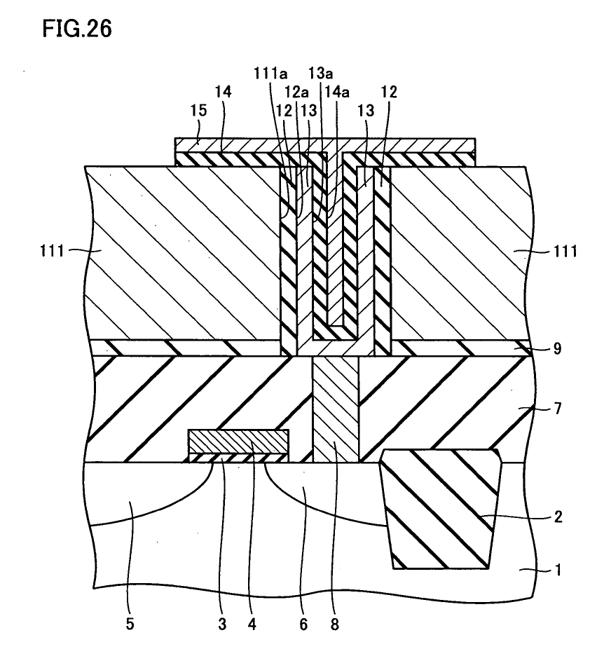

With the photolithography step, conductive film 115 and dielectric film 114 are etched. Consequently, conductive film 15 and dielectric film 14 patterned to form a prescribed pattern are obtained. The structure is shown in FIG. 26.

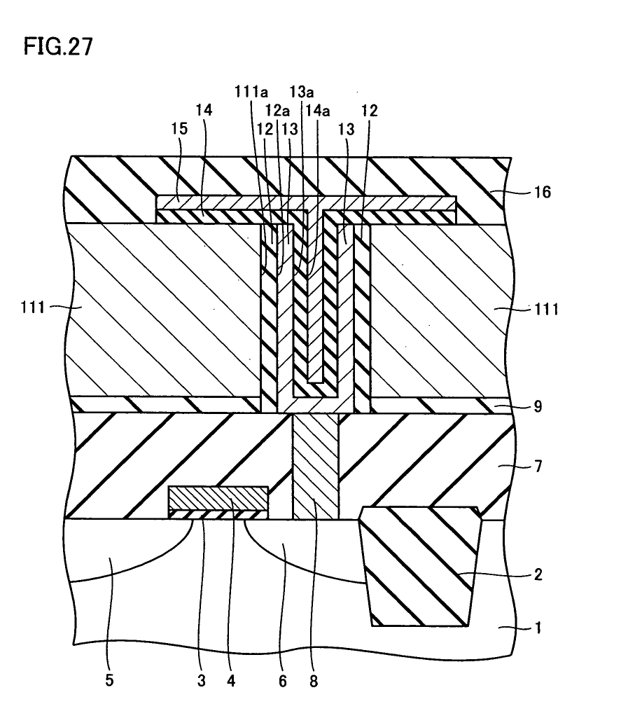

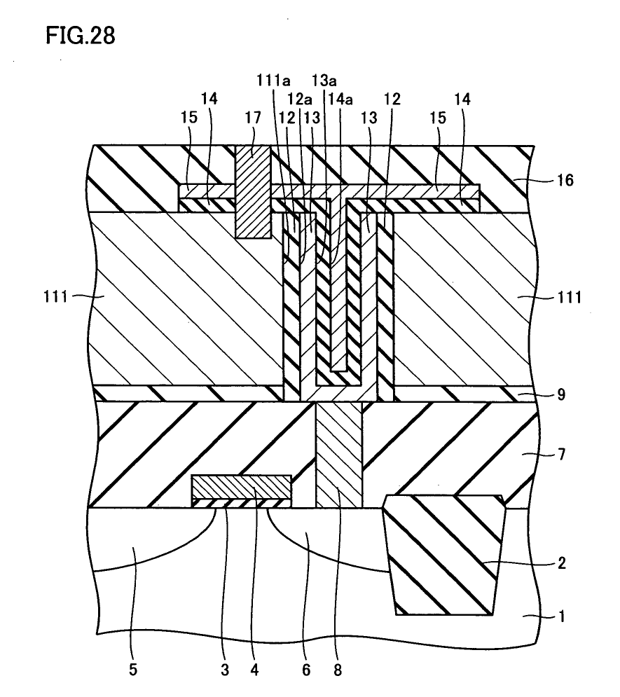

Thereafter, interlayer insulating film 16 composed of a silicon oxide film is formed so as to cover conductive film 15 and dielectric film 14. The structure is shown in FIG. 27. Then, as shown in FIG. 28, plug 17 penetrating interlayer insulating film 16, conductive film 15 and dielectric film 14 to reach conductive film 111 is formed. Plug 17 is fabricated with the barrier metal film composed of TiN and Ti and the W film. Then, a contact hole penetrating interlayer insulating film 16, conductive film 111, silicon nitride film 9, and interlayer insulating film 7 to reach source/drain region 5 is formed. Insulating film 19 is formed along the surface of the contact hole. Contact plug 18 is formed so as to fill the hole formed by insulating film 19. In this manner, the structure as shown in FIG. 16 is obtained.

In the present embodiment, conductive film 111, plug 17 and conductive film 15 constitute the capacitor upper electrode. In addition, dielectric film 12 and dielectric film 14 constitute the capacitor dielectric film. Conductive film 13 implements the capacitor lower electrode.

According to the method of manufacturing a semiconductor device in the present embodiment described above, as in the method of manufacturing a semiconductor device in the first embodiment, after conductive film 13 is formed, the subsequent process steps are performed while conductive film 13 serving as the capacitor lower electrode shown in FIGS. 21 to 23 is always supported by dielectric film 12. In other words, complete exposure of conductive film 13 without support by any support member does not take place. As a result, a disadvantage that conductive film 13 is bent during the manufacturing process of the semiconductor device is prevented, resulting in an excellent shape of the capacitor. In this manner, a yield of the semiconductor device is improved.

### Third Embodiment

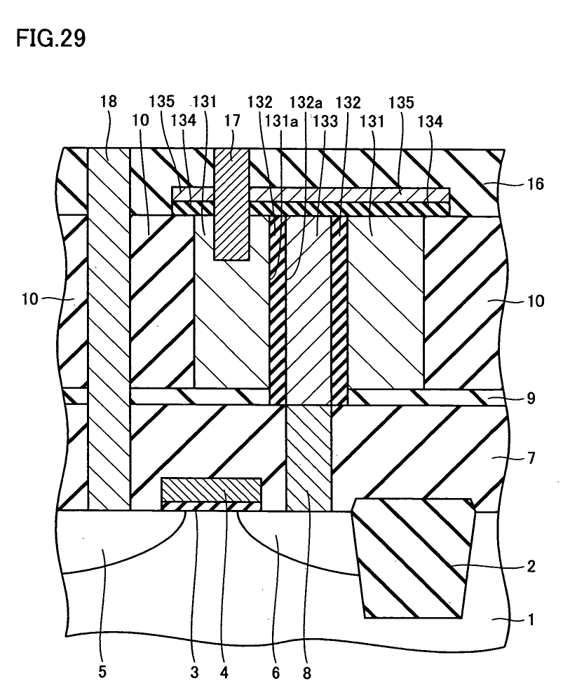

A semiconductor device and a manufacturing method thereof in the present embodiment will now be described with reference to FIGS. 29 to 36. First, a structure of the semiconductor device in the present embodiment will be described with reference to FIG. 29. The semiconductor device in the present embodiment has a structure substantially the same as that of the semiconductor device in the first embodiment shown in FIG. 1. That is, as the same or corresponding components designated by the same reference characters serve in a similar manner and attain the same function, description thereof will not be repeated. On the other hand, the capacitor of the semiconductor device in the present embodiment is slightly different from that in the first embodiment in the structure of the capacitor upper electrode, the capacitor dielectric film and the capacitor lower electrode.

In the semiconductor device in the present embodiment, as shown in FIG. 29, a conductive film 131 composed of TiN is formed along the entire inner surface of the hole formed in interlayer insulating film 10. A dielectric film 132 composed of Ta₂O₅ is formed on the inner surface of a hole 131a formed by conductive film 131. A conductive film 133 composed of polycrystalline silicon containing an impurity is formed so as to fill a hole 132a formed by dielectric film 132. Here, conductive film 133 is shaped like a column or a prism. That is, the capacitor in the present embodiment is of a pillar-type. In addition, a dielectric film 134 composed of Ta₂O₅ is formed so as to cover an upper surface of conductive film 131, dielectric film 132 and conductive film 133. A conductive film 135 composed of TiN is formed so as to cover an upper surface of dielectric film 134. Plug 17 penetrating conductive film 135 and dielectric film 134 to reach conductive film 131 is formed. Plug 17 is fabricated with the barrier metal film composed of TiN and Ti and the W film.

In the semiconductor device in the present embodiment described above, conductive film 131, plug 17 and conductive film 135 constitute the capacitor upper electrode. Dielectric film 132 and dielectric film 134 constitute the capacitor dielectric film. Conductive film 133 implements the capacitor lower electrode.

According to the semiconductor device in the present embodiment described above, the entire surface except for the bottom surface of conductive film 133 can contribute as the capacitor, as in the semiconductor devices in the first and second embodiments. Therefore, the capacitance can be increased.

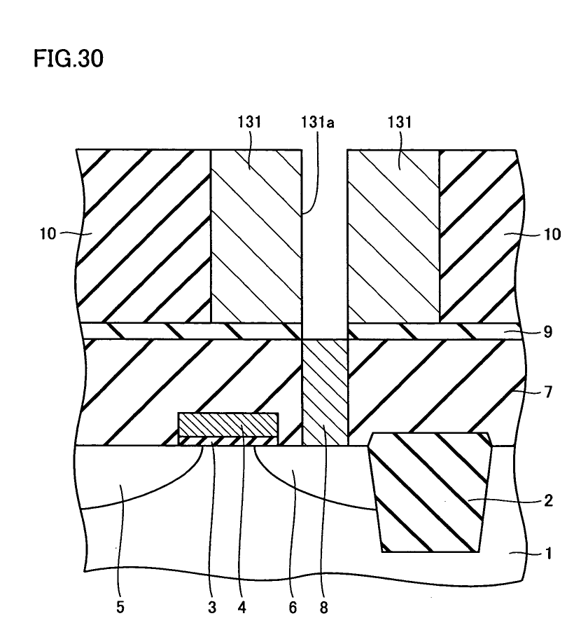

The method of manufacturing a semiconductor device in the present embodiment will now be described with reference to FIGS. 30 to 36. First, the structure shown in FIG. 30 will be described. In FIG. 30, since the structure of silicon nitride film 9 and components below the same is substantially the same as that in the semiconductor device in the first embodiment, description thereof will not be repeated.

In FIG. 30, interlayer insulating film 10 composed of a silicon oxide film is formed on silicon nitride film 9. A hole is then formed in interlayer insulating film 10. Conductive film 131 composed of Ti fills the hole. Thereafter, hole 131a extending in a direction vertical to the main surface of semiconductor substrate 1 is formed in conductive film 131. Contact plug 8 is exposed on the bottom surface of hole 131a. In the present embodiment, however, solely contact plug 8 composed of polycrystalline silicon containing an impurity is exposed on the bottom surface of hole 131a.

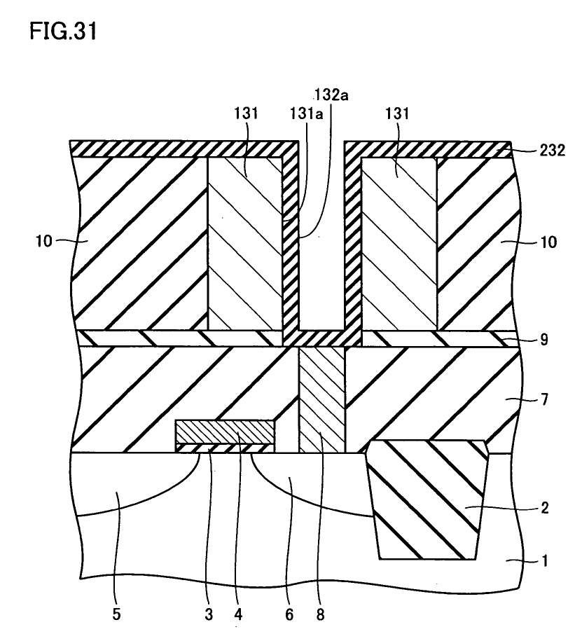

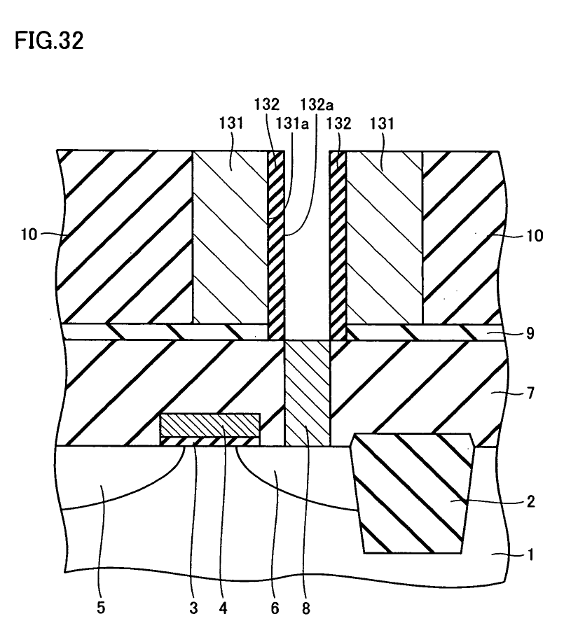

Then, as shown in FIG. 31, a dielectric film 232 is formed along the surface of hole 131a, the upper surface of conductive film 131, and the upper surface of interlayer insulating film 10. Dielectric film 232 is composed of Ta₂O₅. Then, dry etching is performed, to leave dielectric film 132 solely along the inner side surface of hole 131a of conductive film 131, as shown in FIG. 32. Hole 132a is formed by dielectric film 132. The bottom surface of hole 132a is formed by the upper surface of contact plug 8.

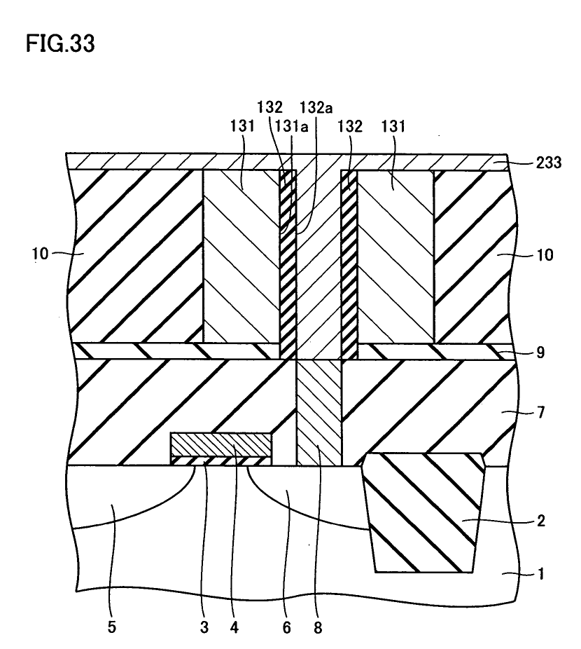

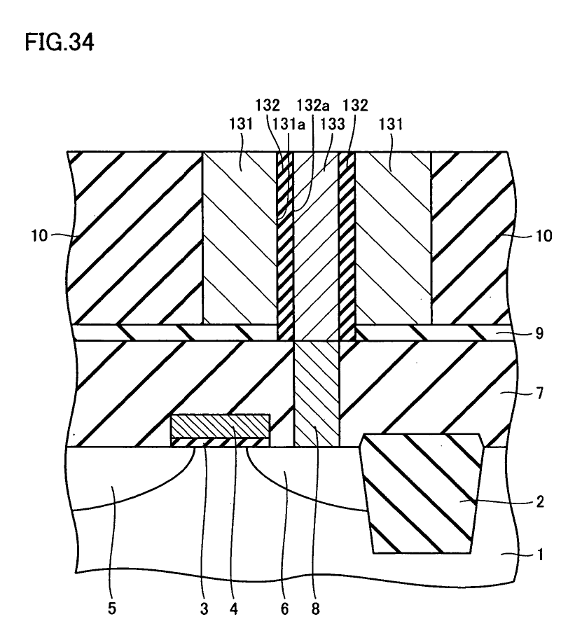

As shown in FIG. 33, a conductive film 233 composed of polycrystalline silicon containing an impurity is formed so as to fill hole 132a and so as to extend along the upper surface of dielectric film 132, conductive film 131 and interlayer insulating film 10. Then, conductive film 233 is polished with CMP. In this manner, the upper surface of interlayer insulating film 10, the upper surface of conductive film 131 and the upper surface of dielectric film 132 are exposed. The structure is shown in FIG. 34.

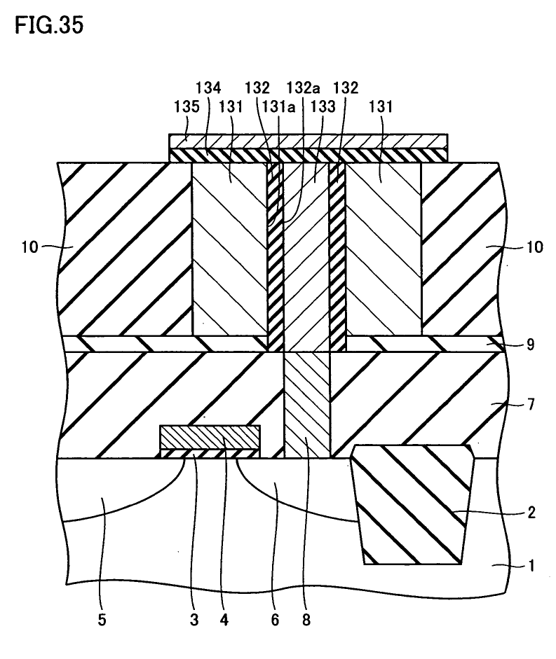

Then, a dielectric film composed of Ta₂O₅ is formed so as to cover the upper surface of interlayer insulating film 10, conductive film 131, dielectric film 132, and conductive film 133. A conductive film composed of TiN is formed on that dielectric film. The aforementioned dielectric film and the conductive film are etched to form a prescribed pattern. In this manner, conductive film 135 and dielectric film 134 are formed as shown in FIG. 35.

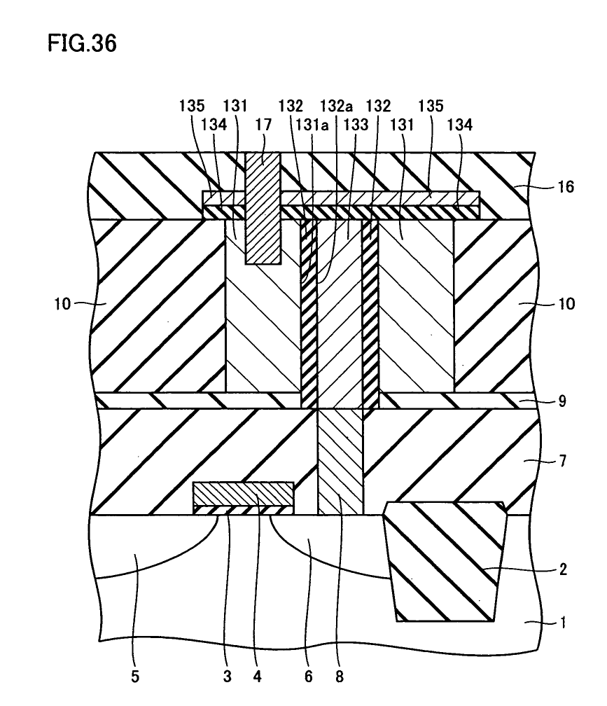

Thereafter, interlayer insulating film 16 composed of a silicon oxide film is formed so as to cover conductive film 135 and dielectric film 134. As shown in FIG. 36, a contact hole penetrating interlayer insulating film 16, conductive film 135 and dielectric film 134 to reach conductive film 131 is formed. Plug 17 fills this hole. Plug 17 is fabricated with the barrier metal film composed of TiN and Ti and the W film. In this manner, the structure as shown in FIG. 36 is obtained.

Then, a contact hole penetrating interlayer insulating film 16, interlayer insulating film 10, silicon nitride film 9, and interlayer insulating film 7 to reach source/drain region 5 is formed. Contact plug 18 fills the contact hole. In this manner, the structure as shown in FIG. 29 is obtained.

According to the method of manufacturing a semiconductor device in the present embodiment described above, complete exposure of the capacitor lower electrode without support by any support member does not take place after the step of forming conductive film 133 serving as the capacitor lower electrode shown in FIGS. 33 and 34. Accordingly, the capacitor lower electrode is not bent, resulting in an excellent shape of the capacitor. Consequently, a yield of the semiconductor device is improved.

### Fourth Embodiment

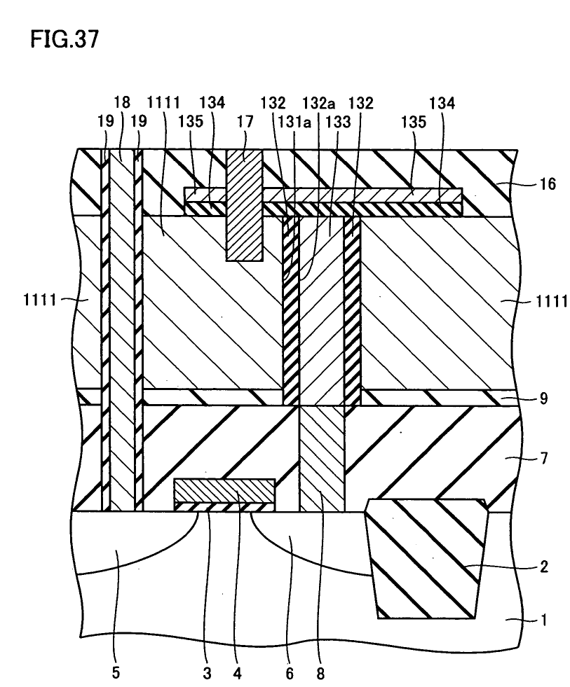

A semiconductor device and a manufacturing method thereof in the fourth embodiment will now be described with reference to FIGS. 37 to 44.

First, a structure of the semiconductor device in the present embodiment will be described with reference to FIG. 37. As shown in FIG. 37, the semiconductor device in the present embodiment has a structure substantially the same as that of the semiconductor device in the third embodiment shown in FIG. 29. That is, as the same or corresponding components designated by the same reference characters serve in a similar manner and attain the same function, description thereof will not be repeated.

In the present embodiment, however, interlayer insulating film 10 shown in FIG. 19 is not formed. In the structure shown in FIG. 37, a conductive film 1111 instead of interlayer insulating film 10 extends in parallel to the main surface of semiconductor substrate 1. In addition, a hole extending in a direction vertical to the main surface of semiconductor substrate 1 is formed in conductive film 1111. Insulating film 19 is formed along the surface of the hole. Contact plug 18 is formed so as to fill the hole formed by insulating film 19. Insulating film 19 isolates contact plug 18 from conductive film 1111.

In the semiconductor device in the present embodiment described above, conductive film 1111, plug 17 and conductive film 135 constitute the capacitor upper electrode. Dielectric film 132 and dielectric film 134 constitute the capacitor dielectric film. Conductive film 133 implements the capacitor lower electrode.

According to the semiconductor device as described above, the entire surface except for the bottom surface of conductive film 133 serving as the capacitor lower electrode can contribute as the capacitor. As a result, the capacitance can be increased.

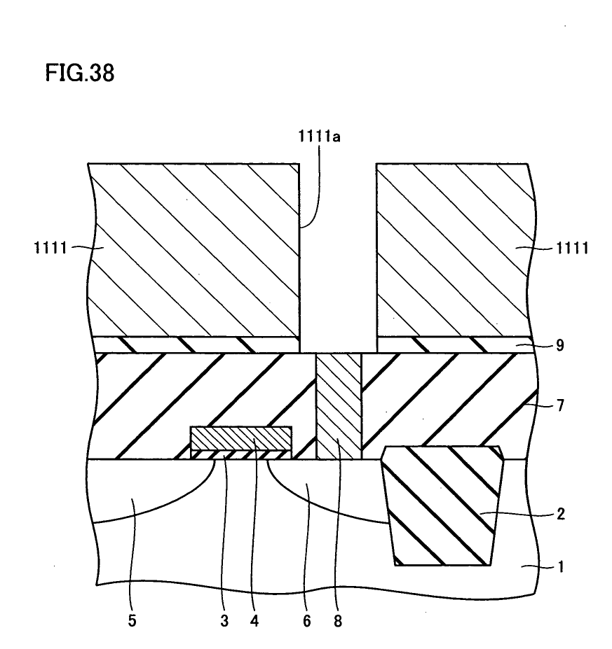

The method of manufacturing the semiconductor device in the present embodiment will now be described with reference to FIGS. 38 to 44. First, the structure shown in FIG. 38 will be described. In the structure of the semiconductor device in the present embodiment shown in FIG. 38, the silicon nitride film and components below the same are manufactured in the steps exactly the same as in a manufacturing method described in the first to third embodiments.

In the structure shown in FIG. 38, conductive film 1111 composed of Ti is formed on silicon nitride film 9. Here, conductive film 1111 is formed on the entire surface of silicon nitride film 9 in a memory cell region. Therefore, interlayer insulating film 10 as described in the third embodiment is not formed.

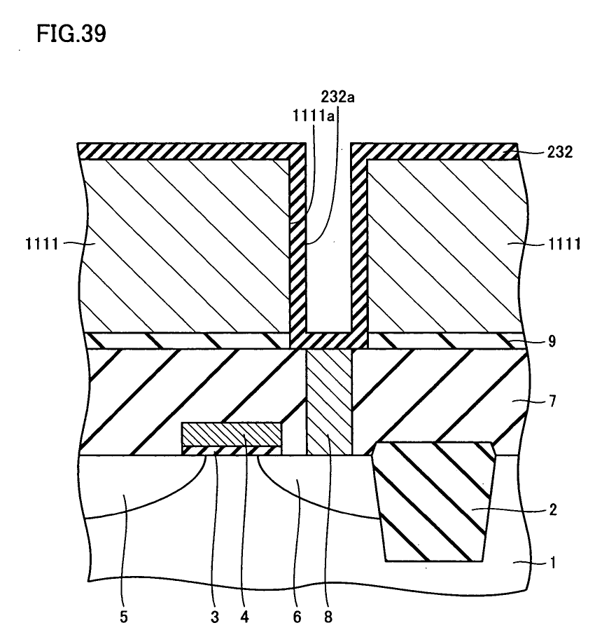

Then, a hole 1111a is formed in conductive film 1111 so as to expose the upper surface of contact plug 8 and interlayer insulating film 7. Thereafter, dielectric film 232 is formed so as to cover the surface of hole 1111a and the upper surface of conductive film 1111. Dielectric film 232 is composed of Ta₂O₅. The structure is shown in FIG. 39.

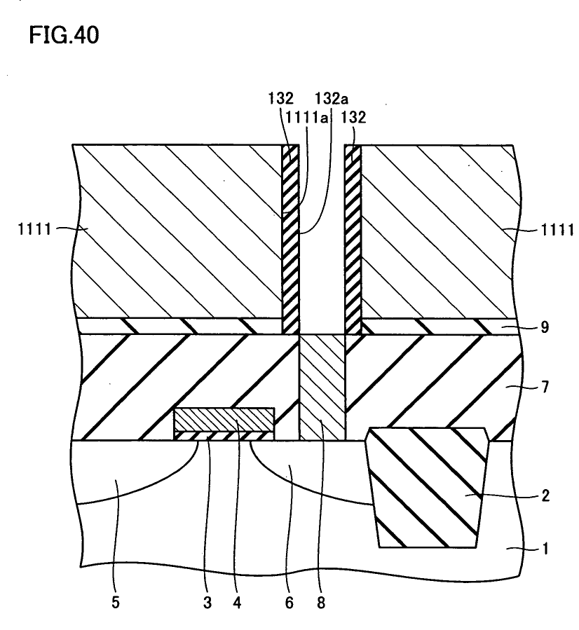

Then, dielectric film 232 is subjected to dry etching, which is anisotropic etching. As a result, dielectric film 132 is left solely on the inner side surface of hole 1111a of conductive film 1111, as shown in FIG. 40. Here, solely contact plug 8 is exposed on the bottom surface of hole 132a formed by dielectric film 132.

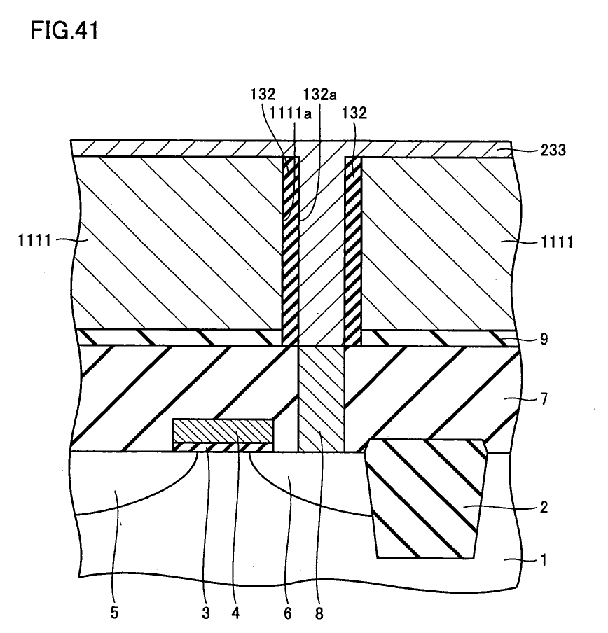

Thereafter, conductive film 233 composed of a polycrystalline silicon film containing an impurity is formed so as to fill hole 132a and so as to cover the upper surface of dielectric film 132 and the upper surface of conductive film 1111. The structure is shown in FIG. 41.

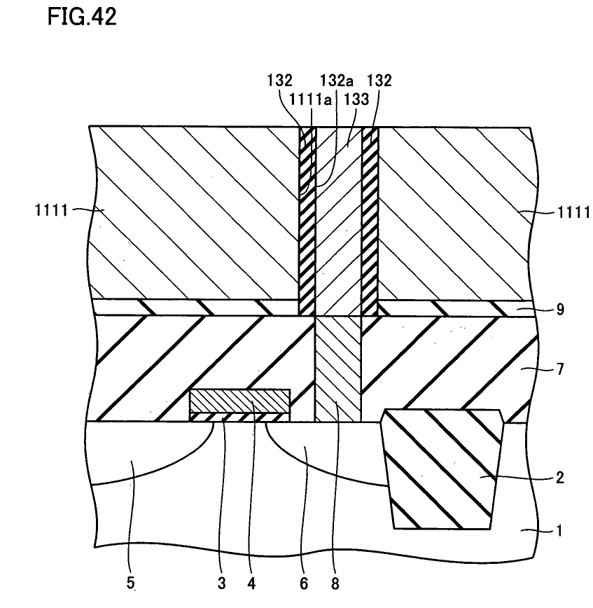

Then, conductive film 233 is etched back or polished with CMP. In this manner, conductive film 133 is formed, and the upper surface of conductive film 1111 and the upper surface of dielectric film 132 are exposed. The structure is shown in FIG. 42.

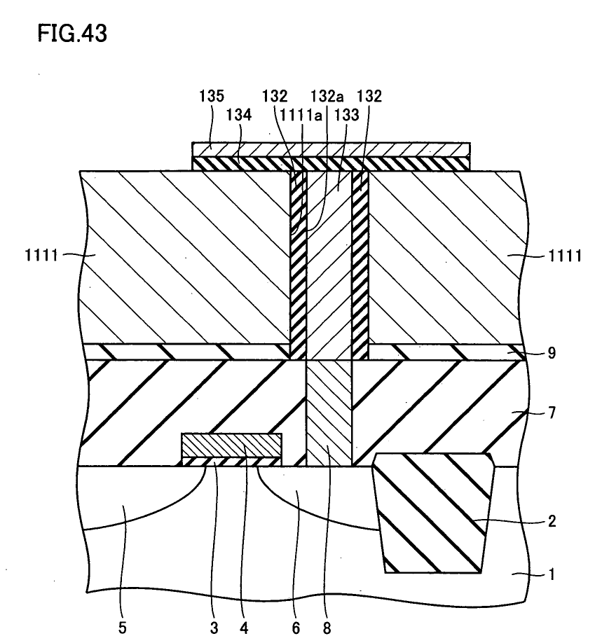

Thereafter, a dielectric film composed of Ta₂O₅ is formed so as to cover the upper surface of conductive film 1111, the upper surface of dielectric film 132, and the upper surface of conductive film 133. A conductive film composed of TiN is formed on that dielectric film. Then, the dielectric film and the conductive film are etched in the lithography process step to form a prescribed pattern. Consequently, dielectric film 134 and conductive film 135 are formed as shown in FIG. 43.

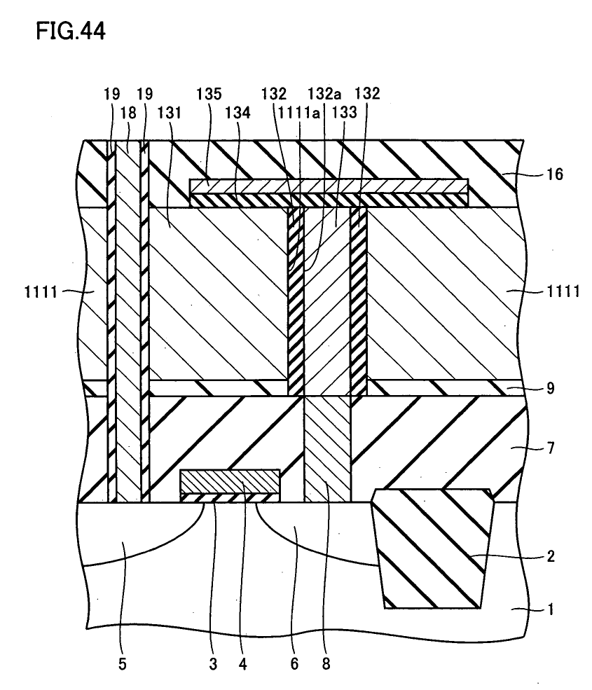

Then, interlayer insulating film 16 is formed so as to cover dielectric film 134 and conductive film 135. Thereafter, a contact hole penetrating interlayer insulating film 16, conductive film 1111, silicon nitride film 9, and interlayer insulating film 7 to reach source/drain region 5 is formed. Insulating film 19 is formed along the inner side surface of that contact hole. Contact plug 18 is formed so as to fill the hole formed by insulating film 19. In this manner, the structure as shown in FIG. 44 is obtained.

Then, a hole penetrating interlayer insulating film 16, conductive film 135 and dielectric film 134 to reach conductive film 1111 is formed. Plug 17 is formed so as to fill that hole. In this manner, the structure as shown in FIG. 37 is obtained.

According to the method of manufacturing a semiconductor device in the present embodiment described above, complete exposure of conductive film 133 does not take place after the step of manufacturing conductive film 133 serving as the capacitor lower electrode shown in FIGS. 41 and 42. In other words, the subsequent process steps are performed while conductive film 133 is always supported by dielectric film 132 after conductive film 133 is formed. Accordingly, bending of the capacitor lower electrode during the manufacturing process as in the conventional art is prevented, leading to the excellent structure of the capacitor. Thus, a yield of the semiconductor device is improved.

Although the present invention has been described and illustrated in detail, it is clearly understood that the same is by way of illustration and example only and is not to be taken by way of limitation, the spirit and scope of the present invention being limited only by the terms of the appended claims.

1. A semiconductor device, comprising:
a capacitor lower electrode of a shape of a round tube or an angular tube, formed above a semiconductor substrate;
a first capacitor dielectric film provided along an entire outer side surface of the capacitor lower electrode;
a first capacitor upper electrode formed so as to cover an entire outer side surface of said first capacitor dielectric film;
a second capacitor dielectric film formed along a surface of a hole formed by said capacitor lower electrode and formed so as to cover an upper surface of said capacitor lower electrode, an upper surface of said first capacitor dielectric film, and an upper surface of said first capacitor upper electrode;
a second capacitor upper electrode formed so as to extend along an upper surface of said second capacitor dielectric film and so as to fill a hole formed by said second capacitor dielectric film; and
a plug formed so as to extend in a direction vertical to a main surface of said semiconductor substrate and connecting said first capacitor upper electrode to said second capacitor upper electrode.

2. A semiconductor device, comprising:
a capacitor lower electrode of a shape of a column or a prism, formed so as to extend in a direction vertical to a main surface of a semiconductor substrate above the semiconductor substrate;
a first capacitor dielectric film formed so as to cover an entire outer side surface of the capacitor lower electrode;
a first capacitor upper electrode formed so as to cover an entire outer side surface of said first capacitor dielectric film;
a second capacitor dielectric film formed so as to cover each upper surface of said capacitor lower electrode, said first capacitor dielectric film and said first capacitor upper electrode;
a second capacitor upper electrode formed so as to cover an upper surface of said second capacitor dielectric film; and
a plug formed so as to extend in a direction vertical to the main surface of said semiconductor substrate and connecting said first capacitor upper electrode to said second capacitor upper electrode.

3. A method of manufacturing a semiconductor device, comprising the steps of:
forming a first conductive film serving as a capacitor upper electrode above a semiconductor substrate;
forming a first hole in said first conductive film so as to extend in a direction vertical to a main surface of said semiconductor substrate;
forming a first dielectric film serving as a capacitor dielectric film along an entire surface of said first hole;
forming a second conductive film serving as a capacitor lower electrode along an entire surface of a second hole formed by said first dielectric film;
forming a second dielectric film along a surface of a third hole formed by said second conductive film, an upper surface of said second conductive film, an upper surface of said first dielectric film, and an upper surface of said first conductive film;
forming a third conductive film serving as a capacitor upper electrode so as to extend along an upper surface of said second dielectric film and so as to fill a fourth hole formed by said second dielectric film; and
forming a plug penetrating said third conductive film and said second dielectric film to reach said first conductive film.

4. A method of manufacturing a semiconductor device, comprising the steps of:
forming a first conductive film serving as a capacitor upper electrode above a semiconductor substrate;
forming a first hole in said first conductive film in a direction vertical to a main surface of said semiconductor substrate;
forming a first dielectric film serving as a capacitor dielectric film along an entire surface of said first hole;
forming a second conductive film serving as a capacitor lower electrode so as to fill a second hole formed by said first dielectric film;
forming a second dielectric film serving as a capacitor dielectric film so as to cover each upper surface of said second conductive film, said first dielectric film and said first conductive film;
forming a third conductive film serving as a capacitor upper electrode so as to cover an upper surface of said second dielectric film; and
forming a plug penetrating said third conductive film and said second dielectric film to reach said first conductive film.
